(19) United States
(12) Patent Application Publication
(10) Pub. No.: US 2026/0091955 A1
(43) Pub. Date: Apr. 2, 2026

(54) SAFETY MONITORING METHOD FOR FREIGHT ELEVATOR

(71) Applicants: Wuchang University of Technology, Wuhan City (CN); Hubei Zhouhui Automotive Technology Co., Ltd., Shiyan City (CN)

(72) Inventors: Qing AN, Wuhan City (CN); Haibo WU, Wuhan City (CN); Qinzhou WEI, Shiyan City (CN); Bing FU, Shiyan City (CN); Ying HE, Wuhan City (CN); Jin YANG, Wuhan City (CN); Qian DENG, Wuhan City (CN)

(21) Appl. No.: 18/903,505

(22) Filed: Oct. 1, 2024

(51) Int. Cl. B66B 5/02

(52) U.S. Cl. CPC B66B 5/02

(57) ABSTRACT

A safety monitoring method for a freight elevator includes: S1: recording a minimum height and a maximum height of all floor doors of a freight elevator; S2: determining whether there are goods that have a height greater than the maximum height and enter the elevator, and if so, directly performing step S6; otherwise performing step S3; S3: determining whether there are goods that have a height greater than the minimum height and enter the elevator, and if so, obtaining the height of the goods and performing step S4; otherwise performing no operation; S4: when the elevator stops, obtaining a height of a floor door on a current floor; S5: determining whether the height of the floor door on the current floor is less than the height of the goods, and if so, performing step the S6; otherwise performing no operation; and S6: issuing an alarm when an elevator door opens.

### TECHNICAL FIELD

The present disclosure relates to the technical field of freight elevators, and in particular, to a safety monitoring method for a freight elevator.

### BACKGROUND

With the continuous urbanization, a freight elevator is widely used in large buildings such as a warehouse, a factory, a hotel, an airport, a station, and a shopping center, to transport heavy goods to a designated floor. During the transportation of goods by staff, a safety accident frequently occurs in the freight elevator. For example, when the staff carry large goods to the elevator manually or by using a forklift, the large goods may obstruct the staff's line of sight and cause a collision between the goods and the freight elevator, resulting in a damage to the freight elevator and affecting carrying efficiency of the goods. In a severe case, a safety accident occurs.

Existing elevator door anti-collision devices generally use an infrared light curtain with a resolution of generally 20 mm-40 mm. Some fine objects such as a human finger and a light strip may not be detected by the infrared light curtain when they are in the middle of an elevator door, resulting in a blind spot and easily causing an accident when the elevator door is closed. Therefore, a corresponding monitoring and management method is needed for carrying goods with a large height in the freight elevator. For example, the public patent CN115849144A discloses a goods identification and anti-collision control method for a freight elevator. The goods identification and anti-collision control method includes: S1: collecting, by a video collection unit, video information, and transmitting the obtained video information to a video processing unit in a wired or wireless manner; S2: determining, by the video processing unit, a possibility of a collision between goods and a freight elevator based on a freight elevator anti-collision algorithm to determine whether to open a door of the freight elevator, and sending a control command to a freight elevator control unit; and if the possibility of the collision between the goods and the freight elevator exceeds a specified threshold, sending a voice warning command to a voice alarm unit; or if the possibility of the collision between the goods and the freight elevator does not exceed the specified threshold, sending no voice warning command; S3: controlling, by the freight elevator control unit, door opening and closing of the freight elevator based on the control command from the video processing unit; and S4: sending, by the voice alarm unit, a warning based on the voice warning command from the video processing unit. The above invention expands a detection range, improves recognition accuracy, eliminates a recognition blind spot, and reduces a probability of a collision event of the freight elevator, thereby effectively improving operating safety of the freight elevator.

However, the above collision avoidance method for the freight elevator also has following disadvantages: Only door opening and closing time is controlled to avoid a collision during the door closing, but a height of the elevator itself and a height of a floor door on a floor where the elevator stops are not considered. For example, a height of a floor door on an underground floor may be low. As a result, goods entering the freight elevator on a ground floor is unable to be transported out from the underground floor, and the goods block the staff's line of sight, which may still cause a collision risk to the goods.

Therefore, in order to solve the above problems, it is necessary to design a reasonable safety monitoring method for a freight elevator.

### SUMMARY

An objective of the present disclosure is to provide a safety monitoring method for a freight elevator, which is simple and convenient, and can obtain a floor height of each floor of a freight elevator and monitor a height of goods entering the freight elevator. When there is a possible collision with an upper side of a floor door, an alarm is issued to reduce a collision probability of the goods and ensure safe operation of the freight elevator.

To achieve the above objective, the present disclosure adopts following technical solutions:

A safety monitoring method for a freight elevator includes following steps:
S1: recording a height of each floor door of a freight elevator to obtain a minimum height and a maximum height;
S2: determining whether there are goods that have a height greater than the maximum height and enter the elevator, and if there are goods that have a height greater than the maximum height and enter the elevator, directly performing step S6; or if there are no goods that have a height greater than the maximum height and enter the elevator, performing step S3;
S3: determining whether there are goods that have a height greater than the minimum height and enter the elevator, and if there are goods that have a height greater than the minimum height and enter the elevator, obtaining the height of the goods and performing step S4; or if there are no goods that have a height greater than the minimum height and enter the elevator, performing no operation;
S4: when the elevator stops, obtaining a height of a floor door on a current floor;
S5: determining whether the height of the floor door on the current floor is less than the height of the goods, and if the height of the floor door on the current floor is less than the height of the goods, performing step S6; or if the height of the floor door on the current floor is not less than the height of the goods, performing no operation; and
S6: issuing an alarm when an elevator door opens.

As a preferred solution of the present disclosure, an infrared rangefinder is disposed on a car wall on a side of the elevator close to a car door, and an extension direction of the infrared rangefinder is towards a car wall on a side of the elevator away from the car door; and a distance between the car wall on the side of the elevator close to the car door and the car wall on the side of the elevator away from the car door is taken as a standard distance; and
when the steps S2 and S3 are performed, whether a front distance detected by the infrared rangefinder is less than the standard distance is determined, and if the front distance detected by the infrared rangefinder is less than the standard distance, there are goods entering the elevator.

As a preferred solution of the present disclosure, there is at least one infrared rangefinder, and heights of a plurality of infrared rangefinders are different; and
when the steps S2 and S3 are performed, a height of a lowest infrared rangefinder among infrared rangefinders detecting that the front distance is equal to the standard distance is used as a height of the goods entering the elevator.

As a preferred solution of the present disclosure, the front distance detected by the infrared rangefinder is sent to a controller in real time; and
when the step S6 is performed, when the elevator door opens, whether a distance between the goods and the elevator door is decreased by a predetermined threshold is determined, and if the distance between the goods and the elevator door is decreased by the predetermined threshold, the alarm is issued.

As a preferred solution of the present disclosure, an anti-collision plate that moves and extends downwards is disposed on an upper side of a car door, and an elastic cushion layer is provided on a side face of the anti-collision plate; and
when the step S5 is performed, if the height of the floor door on the current floor is less than the height of the goods, the anti-collision plate moves downwards such that a height of a lower end of the anti-collision plate from a bottom of a car is the same as the height of the floor door, and the step S6 is performed.

As a preferred solution of the present disclosure, when the step S6 is performed, whether the anti-collision plate is impacted is determined, and if the anti-collision plate is impacted, an elevator monitoring video is uploaded; or if the anti-collision plate is not impacted, no operation is performed.

As a preferred solution of the present disclosure, when the step S6 is performed, alarm modes include an audio alarm and an optical alarm.

As a preferred solution of the present disclosure, when the step S3 is performed, a real-time height of the goods is obtained; and
when the step S5 is performed, whether the height of the floor door on the current floor is less than the real-time height of the goods is determined, and if the height of the floor door on the current floor is less than the real-time height of the goods, the step S6 is performed; or if the height of the floor door on the current floor is not less than the real-time height of the goods, no operation is performed.

The safety monitoring method for a freight elevator in the present disclosure achieves following beneficial effects: The method is simple and convenient, and can obtain a floor height of each floor of a freight elevator and monitor a height of goods entering the freight elevator. When there is a possible collision with an upper side of a floor door, an alarm is issued to reduce a collision probability of the goods and ensure safe operation of the freight elevator.

### BRIEF DESCRIPTION OF THE DRAWINGS

FIG. 1 is a schematic flowchart of a safety monitoring method for a freight elevator according to the present disclosure.

### DETAILED DESCRIPTION OF THE EMBODIMENTS

The following describes the technical solutions in the embodiments of the present disclosure clearly and completely with reference to the accompanying drawings in the embodiments of the present disclosure.

In the following description, terms such as “first” and “second” are merely intended for the purpose of description, and should not be construed as indicating or implying relative importance. The following description provides a plurality of embodiments of the present disclosure, and different embodiments can be replaced or combined. Therefore, the present disclosure can also be considered to include all possible combinations of the same and/or different embodiments described. Therefore, if one embodiment includes features A, B, and C, and another embodiment includes features B and D, the present disclosure should also be considered to include embodiments containing one or more other possible combinations of A, B, C, and D, although such embodiments may not be explicitly described in the following content.

The following description provides examples and does not limit the scope, applicability, or example set forth in the claims. Changes can be made to a function and an arrangement of a described element without departing from the scope of the present disclosure. In various examples, various processes or components may be omitted, replaced, or added appropriately. For example, the described method can be executed in an order different from the described order, and various steps can be added, omitted, or combined. In addition, features described about some examples can be combined into other examples.

### Embodiment 1

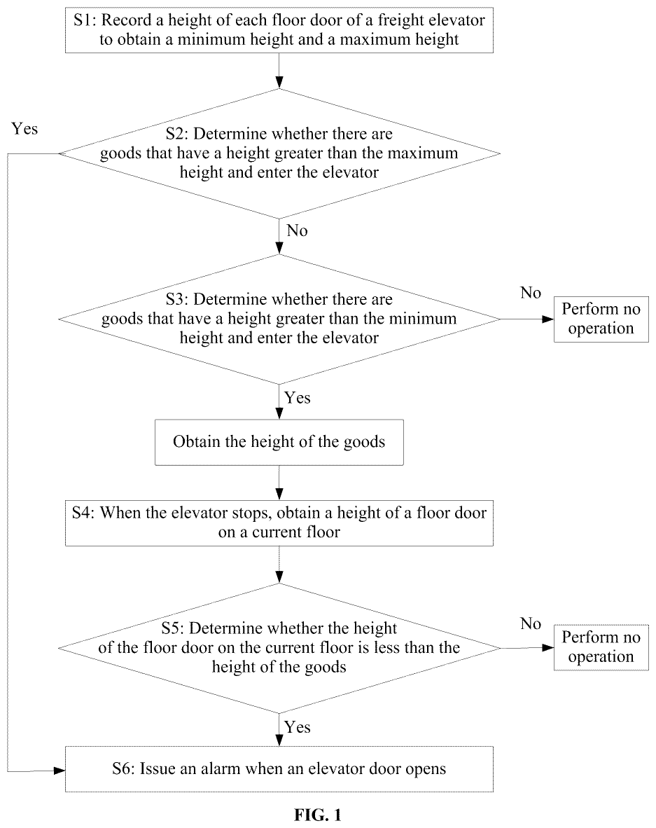

As shown in FIG. 1, FIG. 1 is a schematic flowchart of a safety monitoring method for a freight elevator according to the present disclosure, which shows only one embodiment of the present disclosure. The safety monitoring method for a freight elevator includes following steps.
S1: Record a height of each floor door of a freight elevator to obtain a minimum height and a maximum height.

Owing to a large carrying capacity, the freight elevator is commonly used in factory and construction site structures, and floor doors may have different heights based on customer needs. However, the elevator is limited by clamping linkage between the elevator and a floor door when an elevator door is opened. Therefore, a specification of the elevator itself cannot be changed, and different management can only be carried out for different floor doors. During the management, it is necessary to obtain the height that is of the floor door and allows goods to pass through after the elevator door opens.

Therefore, heights of all floor doors are obtained, and the minimum height and the maximum height are obtained. In this way, the heights of all the floor doors are between the maximum height and the minimum height, facilitating the management.

Certainly, a height of a car door of the elevator is the same as the maximum height.
S2: Determine whether there are goods that have a height greater than the maximum height and enter the elevator, and if there are goods that have a height greater than the maximum height and enter the elevator, directly perform step S6; or if there are no goods that have a height greater than the maximum height and enter the elevator, perform step S3.

Once the goods enter the elevator, if the height of the goods is detected to be greater than the maximum height, the goods need to be managed when being shipped out of the freight elevator, in other words, the step S6 is performed. On the contrary, if the height of the goods is less than the maximum height, it is necessary to further determine whether to perform the management when the goods are shipped out of the elevator, in other words, the step S3 is performed.

There are some goods that can be tilted into the elevator. A height of the goods is less than the maximum height when the goods are tilted but is greater than the maximum height when the goods are upright. In this case, the goods cannot be shipped out of the elevator upright and need to be tilted when being shipped out of elevator. The goods may not be shipped out of the element even they are tilted. Therefore, the management is required.
S3: Determine whether there are goods that have a height greater than the minimum height and enter the elevator, and if there are goods that have a height greater than the minimum height and enter the elevator, obtain the height of the goods and performing step S4; or if there are no goods that have a height greater than the minimum height and enter the elevator, perform no operation.

If the height of the goods is detected to be greater than the minimum height, the goods are likely to collide with or block a passage when being shipped out of the freight elevator. The goods need to be managed based on an actual situation when being shipped out of the freight elevator.

In order to manage the goods, it is necessary to obtain the height of the goods.
S4: When the elevator stops, obtain a height of a floor door on a current floor.

The elevator stops on the current floor, which indicates that goods loading or unloading needs to be performed on the current floor. In order to manage the goods loading or unloading, it is necessary to obtain the height of the floor door on the current floor.
S5: Determine whether the height of the floor door on the current floor is less than the height of the goods, and if the height of the floor door on the current floor is less than the height of the goods, perform step the S6; or if the height of the floor door on the current floor is not less than the height of the goods, perform no operation.

If a height within the freight elevator is greater than the minimum height value and the height of the goods is less than the height of the current floor door, the goods can be loaded or unloaded normally and do not need to be managed. Otherwise, next-step management is carried out.
S6: Issue an alarm when the elevator door opens.

Actually, when the step S6 is performed, when the elevator door opens, whether a distance between the goods and the elevator door is decreased by a predetermined threshold is determined. If the distance between the goods and the elevator door is decreased by the predetermined threshold, the alarm is issued.

That is, when the elevator door opens, if the goods move towards a direction of the car door and a displacement is large, it can be considered that the goods want to be unloaded from the current floor. However, considering that the height of the goods is greater than the height of the floor door on the current floor, there may be a risk of colliding with or even blocking the elevator door when the goods are shipped out of the elevator. Therefore, an alarm reminder is needed to remind freight personnel to pay attention to the height of the goods. The freight personnel determine whether to tilt the goods when shipping the goods out of the elevator, so as to avoid a collision with a top of the floor door.

In the present disclosure, an infrared rangefinder is disposed on a car wall on a side of the elevator close to the car door, and an extension direction of the infrared rangefinder is towards a car wall on a side of the elevator away from the car door. A distance between the car wall on the side of the elevator close to the car door and the car wall on the side of the elevator away from the car door is taken as a standard distance.

Therefore, when the steps S2 and S3 are performed, whether a front distance detected by the infrared rangefinder is less than the standard distance is determined. If the front distance detected by the infrared rangefinder is less than the standard distance, there are goods entering the elevator.

Moreover, there are at least one infrared rangefinder, and heights of a plurality of infrared rangefinders are different. It is best to evenly dispose a plurality of infrared rangefinders from the minimum height to the maximum height, and even ensure that the infrared rangefinder is disposed for the height of each floor door.

When the steps S2 and S3 are performed, a height of a lowest infrared rangefinder among infrared rangefinders detecting that the front distance is equal to the standard distance is used as a height of the goods entering the elevator.

Further, the front distance detected by the infrared rangefinder is sent to a controller in real time.

Certainly, an anti-collision plate that moves and extends downwards is disposed on an upper side of the car door, and an elastic cushion layer is provided on a side face of the anti-collision plate.

Therefore, when the step S5 is performed, if the height of the floor door on the current floor is less than the height of the goods, the anti-collision plate moves downwards such that a height of a lower end of the anti-collision plate from a bottom of a car is the same as the height of the floor door, and the step S6 is performed.

Moreover, when the step S6 is performed, whether the anti-collision plate is impacted is determined. If the anti-collision plate is impacted, an elevator monitoring video is uploaded; or if the anti-collision plate is not impacted, no operation is performed.

Certainly, when the step S6 is performed, alarm modes include an audio alarm and an optical alarm.

It should be noted that when the step S3 is performed, a real-time height of the goods is obtained. That is, the goods may be tilted when entering the elevator, and after the goods enter the elevator, the height of the goods suddenly increases when the goods stand upright. Therefore, obtaining the real-time height of the goods can detect a moment at which the goods stand upright and the height of the goods standing upright.

Herein, a maximum real-time height of the goods is recorded.

Finally, when the step S5 is performed, whether the height of the floor door on the current floor is less than the maximum real-time height of the goods. If the height of the floor door on the current floor is less than the maximum real-time height of the goods, the step S6 is performed; or if the height of the floor door on the current floor is not less than the maximum real-time height of the goods, no operation is performed.

The safety monitoring method for a freight elevator in the present disclosure is simple and convenient, and can obtain a floor height of each floor of a freight elevator and monitor a height of goods entering the freight elevator. When there is a possible collision with an upper side of a floor door, an alarm is issued to reduce a collision probability of the goods and ensure safe operation of the freight elevator.

The present disclosure is not limited to the foregoing implementations, and various changes and modifications may be made to the present disclosure. Those skilled in the art should understand that any modifications, equivalent replacements, and improvements that are made to the above implementations according to the technical essence of the present disclosure shall be included in the protection scope of the present disclosure.

What is claimed is:

1. A safety monitoring method for a freight elevator, comprising following steps:
S1: recording a height of each floor door of a freight elevator to obtain a minimum height and a maximum height;
S2: determining whether there are goods that have a height greater than the maximum height and enter the elevator, and if there are goods that have a height greater than the maximum height and enter the elevator, directly performing step S6; or if there are no goods that have a height greater than the maximum height and enter the elevator, performing step S3;
S3: determining whether there are goods that have a height greater than the minimum height and enter the elevator, and if there are goods that have a height greater than the minimum height and enter the elevator, obtaining the height of the goods and performing step S4; or if there are no goods that have a height greater than the minimum height and enter the elevator, performing no operation;
S4: when the elevator stops, obtaining a height of a floor door on a current floor;
S5: determining whether the height of the floor door on the current floor is less than the height of the goods, and if the height of the floor door on the current floor is less than the height of the goods, performing the step S6; or if the height of the floor door on the current floor is not less than the height of the goods, performing no operation; and
S6: issuing an alarm when an elevator door opens.

2. The safety monitoring method for a freight elevator according to claim 1, wherein
an infrared rangefinder is disposed on a car wall on a side of the elevator close to a car door, and an extension direction of the infrared rangefinder is towards a car wall on a side of the elevator away from the car door; and a distance between the car wall on the side of the elevator close to the car door and the car wall on the side of the elevator away from the car door is taken as a standard distance; and
when the steps S2 and S3 are performed, whether a front distance detected by the infrared rangefinder is less than the standard distance is determined, and if the front distance detected by the infrared rangefinder is less than the standard distance, there are goods entering the elevator.

3. The safety monitoring method for a freight elevator according to claim 2, wherein
there is at least one infrared rangefinder, and heights of a plurality of infrared rangefinders are different; and
when the steps S2 and S3 are performed, a height of a lowest infrared rangefinder among infrared rangefinders detecting that the front distance is equal to the standard distance is used as a height of the goods entering the elevator.

4. The safety monitoring method for a freight elevator according to claim 2, wherein
the front distance detected by the infrared rangefinder is sent to a controller in real time; and
when the step S6 is performed, when the elevator door opens, whether a distance between the goods and the elevator door is decreased by a predetermined threshold is determined, and if the distance between the goods and the elevator door is decreased by the predetermined threshold, the alarm is issued.

5. The safety monitoring method for a freight elevator according to claim 1, wherein
an anti-collision plate that moves and extends downwards is disposed on an upper side of a car door, and an elastic cushion layer is provided on a side face of the anti-collision plate; and
when the step S5 is performed, if the height of the floor door on the current floor is less than the height of the goods, the anti-collision plate moves downwards such that a height of a lower end of the anti-collision plate from a bottom of a car is the same as the height of the floor door, and the step S6 is performed.

6. The safety monitoring method for a freight elevator according to claim 5, wherein
when the step S6 is performed, whether the anti-collision plate is impacted is determined, and if the anti-collision plate is impacted, an elevator monitoring video is uploaded; or if the anti-collision plate is not impacted, no operation is performed.

7. The safety monitoring method for a freight elevator according to claim 1, wherein when the step S6 is performed, alarm modes comprise an audio alarm and an optical alarm.

8. The safety monitoring method for a freight elevator according to claim 1, wherein
when the step S3 is performed, a real-time height of the goods is obtained; and
when the step S5 is performed, whether the height of the floor door on the current floor is less than the real-time height of the goods is determined, and if the height of the floor door on the current floor is less than the real-time height of the goods, the step S6 is performed; or if the height of the floor door on the current floor is not less than the real-time height of the goods, no operation is performed.
